(19) United States
(12) Patent Application Publication
(10) Pub. No.: US 2026/0272739 A1
(43) Pub. Date: Sep. 17, 2026

(54) CUSTOMIZED COMPRESSIBLE ELEMENTS, ASSEMBLIES COMPRISING SAME, AND METHODS OF MAKING SAME

(71) Applicants: Kath Bogie, Cleveland, OH (US); Joseph Lerchbacker, Cleveland, OH (US)

(72) Inventors: Kath Bogie, Cleveland, OH (US); Joseph Lerchbacker, Cleveland, OH (US)

(21) Appl. No.: 19/149,738

(22) PCT Filed: Jan. 24, 2024
(86) PCT No.: PCT/US2024/012736

§ 371 Date: Jul. 21, 2025

Related U.S. Application Data
(60) Provisional application No. 63/481,337, filed on Jan. 24, 2023.

(51) Int. Cl. A61G 5/10; A47C 31/12

(52) U.S. Cl. CPC A61G 5/1045; A47C 31/126

(57) ABSTRACT

A compressible element comprises a resilient material arranged in an open structure having predetermined geometry to provide a desired mechanical property. The resilient material can be 3D printed. The predetermined geometry can comprise a volumetric density of the open structure. A pad can comprise a frame and a plurality of such compressible elements.

### CROSS-REFERENCE TO RELATED APPLICATION

This application claims priority to and the benefit of the filing date of U.S. Provisional Patent Application No. 63/481,337, filed Jan. 24, 2023, the entirety of which is hereby incorporated by reference herein.

### FIELD

This disclosure relates to cushions and, in particular, to cushions that are customizable to have desired material properties.

### BACKGROUND

A pressure ulcer (pressure injury) is a localized injury to the skin and/or underlying tissue, usually proximate to a bony prominence, developed as a result of a combination of interface pressure, friction/shear, and environmental factors such as moisture and temperature. These ulcers are most commonly associated with diabetics, spinal cord injuries (SCI), coma or bed/wheelchair-bound patients, and people who are unable to feel pain from sustained pressure and/or to relieve the pressure/shear that causes the ulcer. Typically, pressure ulcer injuries are categorized by the following stages of severity:
Stage I: Reddening of intact skin that persists despite applied pressure. Stage I pressure ulcers are often coupled with a temperature and/or stiffness change compared to surrounding skin.
Stage II: Damage to or loss of thickness of the dermis, paired with an open wound (broken epidermis). Stage II pressure ulcers can also include open or intact blistering. Generally, these pressure ulcers are relatively shallow.
Stage III: Tissue damage and/or loss is full thickness of the skin, down to and including the subcutaneous tissue. Subcutaneous fat may be visible depending on location, but bone, muscle, or tendon are not visible. Underlying fascia is intact.
Stage IV: Damage is severe enough to expose underlying bone, muscle, or tendon.
Unstageable: Exudate, slough, eschar or other debris obscure or fill the wound bed, preventing proper stage assessment until it is removed.

Sitting on a hard surface or lying in bed produces increased pressures under bony prominences, such as the ischial tuberosities, that exceed intravenous capillary pressure. The combined effect cuts off vascular flow to the high-pressure area, thereby increasing pressure ulcer injury risk. Shearing between the skin and bone can twist and occlude small blood vessels, further promoting ischemia, as well as potentially causing blisters and skin damage at the surface. Moisture resulting from incontinence and sweat can also cause maceration and weakening of skin and tissue, although reduced temperatures may alleviate some of these issues.

Once formed, pressure ulcers are difficult to treat, and the cost of such care-even for a single pressure ulcer—may approach $70,000. As of the date of this application, the total cost of all pressure ulcer treatment and prevention across all patient groups is estimated to easily exceed $1 billion per year in the United States alone.

Currently, long-term wheelchair users have a choice of several different types of pressure-relief wheelchair cushion that are designed to reduce the user's risk of developing a pressure ulcer. Most often, cushions are categorized by the main material used in their construction. The five most common materials are standard and viscoelastic foams, gels, viscous fluids, and air.

These materials may be combined in a variety of ways to produce the cushion. For example, some air-inflated cushions, such as the Roho® line of cushions use inter-connected air cells, allowing the air to flow freely inside the cushion. Another line of air-inflated cushion, from Vicar® use individually sealed chambers, preventing cross-flow. The Jay Medical® Jay® 2 cushion uses gel-filled chamber with a foam substrate to provide support and pressure relief. The chamber is filled with proprietary JAY FLOW™ gel, which has been shown to provide good postural stability. However, many of these commercial cushions cost $300-$450 or more.

A low cost and easy to manufacture and assemble cushion is needed. Specifically, a modular design relying on additive manufacturing technologies would be welcomed. Further, a design whereby a single modular unit could be reconstructed and replaced, either because of a failure of the unit or because of slight changes in the needs of the user (e.g., a change in his or her pressure map), would be a considerable improvement.

### SUMMARY

Described herein, in various aspects, is a compressible element comprising a resilient material arranged in an open structure having predetermined geometry to provide a desired mechanical property.

The predetermined geometry can comprise a volumetric density of the open structure.

In exemplary aspects, the resilient material can be 3D printed.

Pads and systems for using the compressible elements are also disclosed herein.

Methods of making the compressible elements are disclosed herein.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a perspective view of an exemplary compressible element being formed via additive manufacturing as disclosed herein.

FIG. 2 is a perspective view of another exemplary compressible element being formed via additive manufacturing as disclosed herein.

FIGS. 3-5 show exemplary compressible elements having different lattice structures.

FIG. 3 shows a compressible element having 5 mm spacings between segments, with segments oriented at 60 degrees relative to each other.

FIG. 4 shows a compressible element having 6 mm spacings between segments, with segments oriented at 60 degrees relative to each other.

FIG. 5 shows a compressible element having a gyroid structure.

FIG. 6 illustrates a system for additively manufacturing compressible elements as disclosed herein.

FIG. 7 illustrates a dispenser of the system of FIG. 6.

FIG. 8 shows a top view of a pad comprising a plurality of compressible elements as disclosed herein.

FIG. 9 shows a cross-sectional view of the foam pad of FIG. 8.

FIG. 10 is a top view of a pad with a cover retracted to show an inner portion of the pad, including a frame and receptacles defined therein.

FIG. 11 is a pressure map of an individual sitting on a conventional surface.

FIG. 12 is a pressure map of an individual sitting on an exemplary pad as disclosed herein.

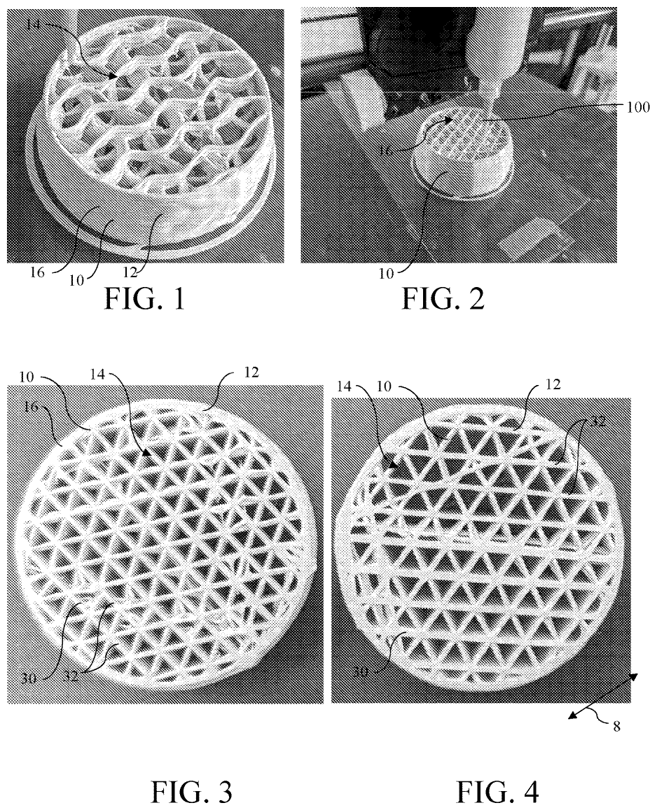

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a compressible element” constitutes disclosure of embodiments in which only a single compressible is provided, as well as disclosure of embodiments in which a plurality of such compressible elements are provided, and so forth.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

The word “or” as used herein means any one member of a particular list and, except where context dictates otherwise, in optional aspects, can also include any combination of members of that list.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, if further aspects, when values are approximated by use of “approximately,” “substantially,” and “generally,” it is contemplated that values within up to 15%, up to 10%, up to 5%, or up to 1% (above or below) of the particularly stated value can be included within the scope of those aspects. In still further aspects, when angular relationships (e.g., “parallel” or “perpendicular”) are approximated by use of “approximately,” “substantially,” or “generally,” it is contemplated that angles within 15 degrees (above or below), within 10 degrees (above or below), within 5 degrees (above or below), or within 1 degree (above or below) of the stated angular relationship can be included within the scope of those aspects.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

A high quality, properly fitting cushion is an essential assistive technology for all Veterans with SCI. Anything less can result in a life-threatening pressure injury. However, many high performance cushions are concurrently high in cost. A wheelchair cushion that matches or exceeds the performance of current commercial cushions at a greatly reduced cost can provide a value-driven engineering (VdE) solution for effective pressure injury prevention and treatment. A VdE cushion could also be provided for a wider range of at-risk individuals before pressure injury problems manifest in order to enhance maintenance of tissue health.

Disclosed herein is a compressible element 10 comprising a resilient material 12 arranged in an open structure 14 having predetermined geometry to provide a desired mechanical property. In some aspects, the desired mechanical property can comprise a desired durometer or distribution of durometers. In other aspects, the desired mechanical property can comprise a plurality of respective displacements at different applied pressures or forces.

The resilient material 12 can further comprise an outer shell 16 that at least partially surrounds the open structure 14. Optionally, the outer shell 16 can fully surround the open structure 14. In other aspects, the outer shell 14 can only partially surround the open structure 14. In some aspects, the outer shell 16 can comprise the same material as the open structure 14. For example, optionally, in these aspects, the open structure 14 and the outer shell 16 can be 3D printed from the same material. The outer shell 16 can partially or fully enclose the open structure 14. For example, in some aspects, the shell can define smaller spacings between adjacent constituent elements (e.g., 3D-printed segments) than the open structure 14. In other aspects, the outer shell 16 does not define any spacings between adjacent constituent elements.

In some optional aspects, the compressible element 10 can have a domed upper surface 20. For example, the domed upper surface 20 can be hemispherical or generally hemispherical. In other aspects, the compressible element 10 can have any suitable shape including, for example, a sphere, a cylinder, a polygonal prism (e.g., rectangular, triangular, or hexagonal prism) a combination of a cylinder and hemisphere, or an irregular shape. In various aspects, the compressible element can have the shape of a seat. Optionally, the seat can define recesses that receive and/or are complementary to the buttocks of a user. In other aspects, it is contemplated that the compressible element can be a pad, shoe insole, a mattress, or other structure which is compressed in response to engagement with a user (e.g., a patient). In further aspects, it is contemplated that the compressible element can be an insert that is configured to be received within a receptacle of a seat or pad as further disclosed herein.

In some aspects, the compressible element can comprise a plurality of regions having respective predetermined mechanical properties. For example, the respective predetermined mechanical properties of the plurality of regions can be based on a pressure map of a particular individual (e.g., patient). Accordingly, in some aspects, the compressible element can be sized to provide cushioning for an entire seat or substantially an entire seat. For example, the compressible element can have a width of at least 10 inches (e.g., from 10 inches to 24 inches), or at least 12 inches (e.g., from 12 inches to 24 inches), or at least 14 inches (e.g., from 14 inches to 24 inches), or at least 16 inches (e.g., from 16 inches to 24 inches). In further aspects, the compressible element can have a length of at least 10 inches (e.g., from 10 inches to 24 inches), or at least 12 inches (e.g., from 12 inches to 24 inches), or at least 14 inches (e.g., from 14 inches to 24 inches), or at least 16 inches (e.g., from 16 inches to 24 inches). In various aspects, the compressible element can have the shape of a scat. Optionally, the seat can define recesses that receive and/or are complementary to the buttocks of a user. In some aspects, the compressible element can be unitarily formed (e.g., via 3D printing). Optionally, the compressible element need not be received within a pad as disclosed herein. Rather, the compressible element itself can serve as the pad. Optionally, the compressible element can be received within a cover. Optionally, a seat can comprise a compressible element as disclosed herein and an overlay (e.g., a foam pad) positioned thereacross.

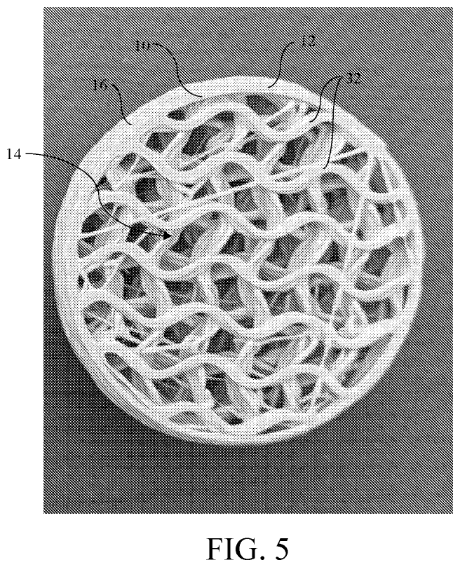

In some aspects, the open structure can comprise a lattice 30, the lattice comprising a plurality of crossing material segments 32. For example, referring to FIGS. 3-4, the plurality of crossing material segments 32 can be straight or substantially straight. In some exemplary, optional aspects, the open structure can comprise triangular prism spaces between the lattice. Referring to FIG. 5, in some aspects, the plurality of crossing material segments 32 can be wavy.

In various aspects, at least a portion of the open structure 12 comprises a gyroid infill (FIG. 5). That is, the open structure 12 can be formed to have the structure of a gyroid, which can have a three-dimensional structure that is formed by a plurality of intersecting, two-dimensional wavy structures. Optionally, it is contemplated that the gyroid structure can be created through the continuous extrusion of wavy lines, with each layer being different, thereby creating an undulating pattern that provides strength and resistance in all directions.

In some aspects, the predetermined geometry can comprise a volumetric density of the open structure. For example, in aspects in which the open structure comprises a lattice, and the lattice comprises a plurality of crossing material segments, the volumetric density can be determined at least in part by selected spacings between adjacent segments 32 that are spaced along a transverse axis 8.

In exemplary aspects, the resilient material 12 can comprise polymer. For example, in some aspects, the resilient material 12 can comprise silicone (e.g., silicone gel).

Accordingly, disclosed herein are durable, low-density, low-durometer compressible elements that can serve as load distributors. In some optional aspects, the compressible elements can be made from off-the-shelf silicone caulk. To tune their loading and impact damping properties, several classes of these silicone constructs can be used, each with different infill densities and patterns. In one example, changing infill patterns from standard 60° lines infill geometry (FIGS. 3-4) with 6 mm spacing to a gyroid infill pattern with the same density resulted in a 5% decrease in material use, but a 47% decrease in vertical construct stiffness, making it ideal for low-load scenarios or when maximum impact damping is required. With a wide variety of mechanical properties available through the changing of internal geometries, these load distribution constructs are an excellent candidate for the creation of modular pressure relief systems customized to each user.

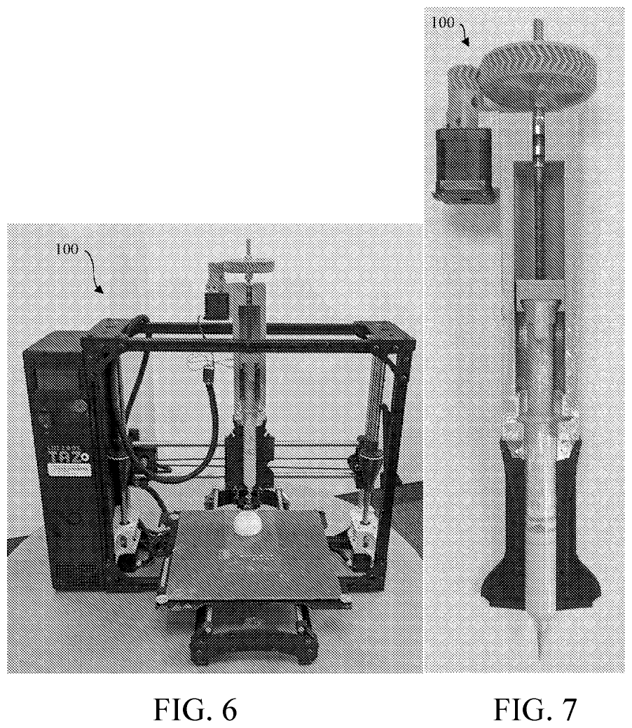

Referring to FIGS. 6-7, a method of making the compressible elements disclosed herein comprises 3D printing a compressible element.

In some aspects, a 3D printer 100 can comprise a tubeless, direct write slurry dispensing system (FIG. 7). A low-cost and simple, computer-controlled syringe pump and a cartridge filled with the printing fluid can mount directly onto a 3-axis gantry of a commercially available large print volume filament-based desktop 3D printer. The syringe pump's high-torque lead screw drive can provide sufficient pressure to print high-viscosity fluids, such as silicone caulks, epoxies, or powder slurries. Small dispensing needles can be used. For example, in some aspects, a dispensing needle can have an inner diameter of less than 2 mm, less than 1.5 mm, or less than 1 mm. In some aspects, plastic components of the system can be printed from PLA plastic on the 3D printer before modification, and the modification can be easily reversible. Non-plastic components, such as the lead screw of the syringe pump and fasteners, can be sourced from readily available, low-cost hardware. This system can allow for reliable gel printing at a fraction of the cost of other commercially available systems.

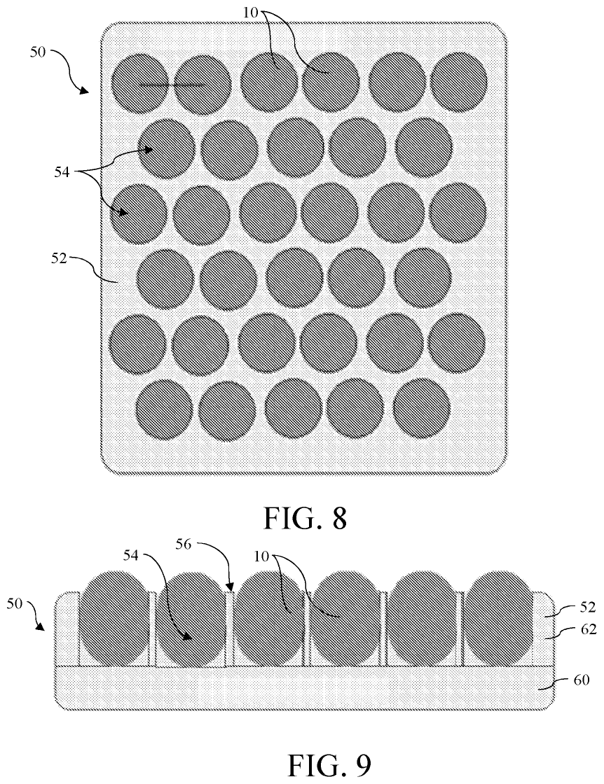

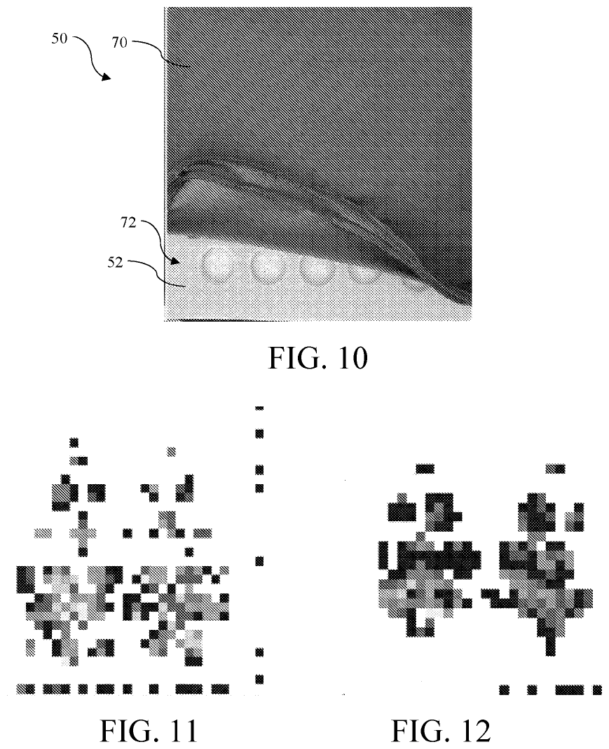

Referring to FIGS. 8-9, disclosed herein is a pad 50 comprising a frame 52 defining a plurality of receptacles 54 and a plurality of compressible elements 10 as disclosed herein. A respective compressible element 10 of the plurality of compressible elements can be positioned within each receptacle 54 of the plurality of receptacles.

The frame 52 can comprise, for example, foam or other resilient material. In some aspects, the frame 52 can comprise fibrous material (e.g., cotton).

In some aspects, each compressible element 10 can be provided to have the same or substantially similar material properties as each other compressible element of the plurality of compressible elements. In other aspects, at least one compressible element is provided to have at least one material property that differs from at least one other compressible element of the plurality of compressible elements. For example, each compressible element provided in each receptacle can be tailored to provide a particular compressibility or other material properties for each region across the pad 50. In some aspects, each compressible element 10 can be tailored for a particular individual. For example, a pressure map (FIG. 11) of a user seated on a surface can be taken to determine which areas are subject to particularly high or low pressures, and the compressible elements 10, and their respective portions, can be selectively formed to reduce high pressure areas. In some exemplary aspects, it is contemplated that a cushion, seat, or pad can be 3D printed to integrally form a plurality of portions that have different mechanical properties to provide a customized compression profile. Thus, in exemplary aspects, it is contemplated that the pad 50 can be provided as a single article that is customized, based on a patient's seated compression map, to have areas or portions of high and low compressibility.

FIG. 11 illustrates a pressure map of the user seated on a surface, and FIG. 12 illustrates a pressure map of the same user seated on the pad 50. In this example, the maximum pressure experienced by the user dropped from 7.43 kPa to 5.5 kPa, or a 26% reduction. Further, the average pressure measurement dropped from 1.77 kPa to 1.21 kPa by providing the pad 50. Additional details of providing pressure maps and customizing cushions are provided in U.S. Pat. No. 10,653,573, granted May 19, 2020, the entirety of which is hereby incorporated by reference herein for all purposes.

In exemplary aspects, the pad 50 can be sized for a seat. Optionally, in these aspects, the pad can be sized for a wheelchair seat. In some aspects, the pad 50 can have a thickness of less than 5 inches (e.g., optionally, less 4.5 inches or less). In some aspects, the frame can have an outer surface 56 (e.g., an upper surface), and the compressible elements 10, when received in the receptacles 54, can protrude outwardly from the outer surface 56.

In some aspects, the pad 50 can have a width from 15 inches to 25 inches (e.g., about 18 inches). In some aspects, the pad 50 can have a length from 15 inches to 25 inches (e.g., about 18 inches).

In exemplary aspects, the receptacles 54 of the frame 50 can be arranged in a plurality of rows. For example, the frame 50 can define between 2 and 12 receptacles. In some aspects, the receptacles 54 of a given row can be evenly spaced. For example, adjacent receptacles 54 can be spaced center-to-center by about 3 inches. In other aspects, the receptacles 54 of a given row can be unevenly spaced. It is contemplated that the center-to-center spacing can be a function of the receptacle dimensions. For example, the receptacles 54 can be sized to receive the compressible elements 10. In some aspects, the receptacles can have slightly smaller dimensions than the compressible elements 10 so that the receptacles expand to receive the compressible elements. In one example, for compressible elements 10 having a diameter of about 2.5 inches, the receptacles 54 can have inner diameters of about 2 inches. Adjacent receptacles 54 can be spaced center-to-center by about 3 inches to provide ½ inch spacing between outer surfaces of adjacent compressible elements 10.

In some aspects, adjacent rows can be aligned in transverse columns. In other aspects, adjacent rows can be offset by half of the center-to-center distance, as illustrated in FIG. 8.

In exemplary aspects, the frame 52 can comprise a base 60 and an upper portion 62 that extends from the base 60. The upper portion 62 can define the receptacles 54. In some aspects the base and the upper portion can comprise different materials. For example, the base 60 and upper portion 62 can comprise different foams having different durometer. In one example, the base can comprise N90 foam, and the upper portion 62 can comprise C44 foam. In some aspects, the base can have a thickness of about 1 inch, and the upper portion can have a thickness from 1 inch to 3 inches (e.g., about 2.5 inches).

In some aspects, the pad 50 can comprise a cover 70 defining an interior 72. The frame 50 and plurality of compressible elements 10 can be received within the interior of the cover. The cover 70 can retain the compressible elements 10 within the receptacles 54. Further, the cover 70 can provide a vapor barrier and/or provide desirable heat transfer properties (e.g., with a high ability to dissipate heat).

### Example 1

Exemplary aspects of the compressible elements, which in some embodiments are referred to as “inserts,” are provided below. The inserts below describe exemplary materials, structures, and use configurations. However, it should be understood that embodiments should not be limited to the embodiments or materials disclosed below. Still further, it should be understood that the compressible elements disclosed herein need not be inserts. Rather, an exemplary compressible element can be a unitary structure having customized material properties depending on what is needed for a particular patient. The compressible element need not have a consistent open structure throughout the compressible element. For example, it is contemplated that the compressible element can have different structures or densities in different regions to provide non-uniform material properties (e.g., variable compressibility).

A range of novel dynamically responsive materials developed for the non-medical market and suitable for use in seating assistive technology were identified. These materials are produced in very high volume making them available at a correspondingly low cost. Polymeric balls (e.g., spheres) filled with gel or air have become widely available, principally as toys with no specific function. The material properties of these polymeric balls, i.e. high viscoelastic deformability and low thermal coefficient, indicated that they are also ideally suited for use in a modular seating support system, marrying the strengths of the ROHO® architecture with the comfort and postural stability of the JAY Medical cushions. Also, the exterior of these polymeric balls is both waterproof and washable. These material characteristics meet several of the basic design criteria for a high-performance wheelchair cushion. In exemplary aspects, and as further disclosed herein, it is contemplated that a plurality of polymeric balls can be selectively positioned within a pad or cushion structure to provide variation in compressibility based upon a seated pressure map of a given patient. It is contemplated that the polymeric balls can have varying compressibility and can be selectively removed and/or replaced to modify the compression properties of the pad or cushion.

Preliminary work has shown that these polymeric ball materials can provide the same, or superior, pressure relief characteristics in an advanced seating support device at a significantly reduced cost. The thermal conductivity characteristics of these materials support a healthy microenvironment with low moisture and temperature levels. There is a need to further investigate the concept that dynamically responsive materials can be incorporated into a VdE modular cushion designed to provide both pressure relief and postural stability. In some optional aspects, it is contemplated that the disclosed devices and systems can provide a customizable modular cushion that combines the performance strengths of the ROHO® and JAY® cushions with the economy of nonproprietary, widely available materials.

Additive manufacturing enables construction of silicone balls with controllable compression properties for the same compression response that are nearly 50% lighter. As with gel balls, the material used to construct the additively manufactured compressible inserts is very low cost and generally used for non-clinical applications. Inserts were initially constructed using the EnvisionTec 3D-Bioplotter™ printer to establish proof-of concept.

Varying the inner perfactories, or structured interior, modified the stiffness by up to 40%, replicating the variation in the five gel ball classes previously developed. Preliminary testing also indicates that in addition to being lighter, the additively manufactured inserts of the present invention can be made with modified surface properties so they ‘stick’ in the containment layer wells.

Five classes of inserts have been additively manufactured using desktop 3D printers (modified to enable extrusion printing of soft materials. The inner perfactories, or structured interior, have been varied in order to modify stiffness replicating the variation in the five gel ball classes previously developed.

Prototype modular cushions were assembled for pre-clinical testing using ISO 16840-2 procedures. The overall design criteria for the modular cushion included:
Maximum unloaded cushion height of 4.25″, leading to a maximum gel ball diameter of 2.5″ (3″ foam base+radius of gel ball).
Overall weight no greater than a Jay Medical Jay® 2 cushion of the same base dimensions.

18″×18″ prototype cushions for mechanical testing were assembled using 1″ thick N90 firm open-cell polyurethane foam (PUF) as the supporting base layer and 2″ thick C44 medium-soft PUF for the containment layer. The containment layer was machined to create 2″ diameter holes uniformly distributed in a 6×6 array with 3″ on-center spacing to house a hexagonal-close-packed array of polymeric stress balls. Each ball was at least 50% contained by the foam substrate ensuring positional stability as the balls compressed and spread under applied loads representative of seating.

Gel balls of varying densities were created by injecting Part A monomer and Part B cross-linker into the spheres with a syringe. Injection through the manufacture's seal was water tight and leak-proof. Polymerization occurred within the sphere, for ease of fabrication. By varying the monomer to cross-linker ratio, precise control over both the modulus and density of the gels could be obtained. Five classes of balls were produced ranging from highly compliant to moderately stiff (Table 1).

TABLE 1
Gel ball characteristics

| | | Maximum |
|---|---|---|
| | | displacement |
| Ball | | under 500 g load |
| class | Composition | (mm) |
| I | Stock balls | 17.20 |
| II | 100 mL of Part A | 12.54 |
| III | 1:30, Part B:Part A | 15.54 |
| IV | 1:15, Part B:Part A | 14.84 |
| V | 1:10, Part B:Part A | 6.65 |

ISO Standard 16840 describes standards relating to wheelchair seating. It is important to note that rather than define performance criteria or thresholds, the ISO Standard 16840 was developed to enable reporting of industry-wide benchmarks. In a pilot development study, the modular cushion's effectiveness under various mechanical loading conditions was examined using four main tests to assess the hysteresis, impact damping, and recovery properties, as well as the cushion's response to being overloaded. The response to a warm and humid microenvironment, another important factor in pressure injury development, was assessed using a Sitting MicroEnvironment Simulator (SMES) developed. A Materials Testing Systems (MTS, Eden Prairie, MN) 810® uniaxial servo-hydraulic loading rig using a 5000 lb. load cell, set to a ±250 lb. range (0-5 Volts), and +/−63.5 mm displacement measurement range was used for all testing.

ISO 16840-2 mechanical and microenvironmental tests were performed on six cushions: 1) ROHO® High Profile air-cell based cushion; 2) ROHO® Low Profile air-cell based cushion; 3) Jay® Medical Jay® 2 gel and foam based cushion; 4) Baseline modular cushion with high compliance (Class I) balls; 5) Baseline modular cushion with moderate compliance (Class III) balls; and 6) Fitted modular cushion created using the Cushion Fitting Algorithm (CFA).

The ISO 16840-2 mechanical tests utilize two special devices for applying load to the cushion that are designed to mimic different aspects of human anatomy. The Loaded Contour Jig (LCJ) represents the geometry and loading conditions of the skeleton, specifically the ischial tuberosities and femoral trochanters and is used to test loaded contour depth and overload deflection. The LCJ is defined in the ISO standard as providing a means of loading cushions with an indenter that represents the ischial tuberosities and trochanters. The loaded contour depth and overload deflection tests measure bottoming out and the ability of the cushion to contour under load by representing buttock loading.

The ISO-standard Rigid Contour Loading Indenter (RCLI) is designed to match the geometry of the soft tissue of the human seating surface. The RCLI is rigid compared to the cushion, and hence will not deform appreciably under test loading, unlike actual human soft tissue. The RCLI was used to determine load-deflection, hysteresis and recovery characteristics as defined in the ISO 16840-2 standard.

As described below, each mechanical test was repeated three times for each cushion. Interface pressure data between the indenter and the cushion was obtained concurrently using the CONFORMat® (Tekscan®, South Boston, MA) pressure system.

Hysteresis: Before each trial, cushions were pre-conditioned by loading using the RCLI for 3 cycles of 830N+10N for 120-180 s, and then allowed to recover for 120-180 s.

After pre-conditioning, the cushion was allowed to recover for another 300 s. A baseline load of 8-10N was applied for 120 s±10 s, and displacement measurement zeroed. Load was then increased by 25N/s in steps of 250N±5N to a maximum load of 750N±5N. Cushion platform displacement was measured at each time point.

Impact damping testing: Impact damping provides information about the cushion's ability to absorb vibration and peak pressures associated with sudden high loading. Impact damping is a dynamic variable related to cushion material hysteresis and provides a measure of the cushion's ability to maintain postural stability under dynamic loading conditions. The impact damping test protocol followed the procedure described in the ISO 16840-2 standard. The cushion mounting was modified so that lift blocks raised the back of the cushion to an angle of 10°±1° to the horizontal. This initial configuration is designed to mimic the configuration of the wheelchair user and cushion at the start of a curb drop off. The angled cushion was then loaded to 500N±10N using the RCLI. The cushion was loaded using load-control mode, so that the MTS could attempt to keep a constant 500N on the load cell. The displacement measurement was zeroed at 500N. The blocks were then quickly removed, causing the cushion, to fall a short distance, leaving contact with the RCLI. As the cushion fell away from the RCLI, a drop in load was recorded. The MTS attempted to restore the 500N load. During this response, displacement data from the MTS was recorded. The cushion was allowed to recover, with no applied load, for 300 s between trials.

Loaded contour depth and overload deflection testing: A cushion is considered to be ‘bottomed-out’ when an increase in load does not produce an increase in deflection. It is important for user safety that the cushion does not ‘bottom-out’ during conditions of normal use. The overload test measures the amount of deflection resulting from an increase in load of 33% over the load test maximum. A cushion that has been loaded beyond the margin of safety is identified when an increase in load does not produce a commensurate increase in deflection that is more than 5 mm. In contrast to the RCLI, the LCJ represents loading only in the ischial region. Although, the cushion will not necessarily bottom-out under the standardized overload deflection testing protocol, a load of 180N represents approximately 20% body weight for a 200 lb wheelchair user. This can also be considered as a local pressure of over 190 mmHg acting through the LCJ contact region, which is significantly in excess of acceptable applied pressure levels.

Overload deflection testing of the cushion was carried out immediately following recovery testing. Alignment of the cushion so that the ‘ischial tuberosities’ of the LCJ were 125 mm±25 mm from the back edge of the cushion was confirmed. With the 8-10N load from the LCJ still being applied, the displacement measurement was zeroed (L₀). A 135N±5N load was then applied to the cushion using the LCJ for 300 s±10 s _{(L135)}. After this pause, the load was increased to 180N±5N for 300 s±10 s _{(L180)}, before reducing the load back to 8-10N. Displacement was measured after each 300 s pause. After each Overload-Deflection trial, all load was removed from the cushion and it was allowed to recover for 300 s±10 s before repeating the loading protocol two more times for a total of three repetitions.

### Microenvironment (Temperature/Humidity) Testing

In order to test the interface microenvironment of the cushions, a Sitting MicroEnvironment Simulator (SMES) was designed and constructed to match ISO 16840-2 standards with the goal of matching the functional technical specifications of previous test fixtures but with increased reliability and longevity. These specifications were to:
Have the geometry of the RCLI.
Produce a stable 37° C.±1° C. at the interface surface when exposed to air to mimic body heat.
Deliver 0.4 kg/m² per day (or 13 mL/hour±1 mL/hour for the given surface area) of water to the interface surface to mimic sweat.
Deliver a constant load of 300N±10N for 2 hours.

The SMES uses nichrome resistive heating wire sealed to the interface surface using silicone to generate heat. A thermistor embedded in the left ischial tuberosity region forms part of a Wheatstone bridge, along with a potentiometer that serves as a control circuit to regulate the amount of current delivered to the two loops of resistive wire from a 12V, 1.25 A DC power supply. The control circuit is calibrated using the potentiometer so that when exposed to ambient air, the surface temperature of the SMES reaches equilibrium at 37.2° C.±1° C. No membrane or micro-scale pores are needed in order to deliver “sweat” to the interface. Moisture is delivered from an external reservoir using a peristaltic pump set to deliver 13 mL/hour of water pumped through IV tubing down the center of the SMES's interface surface. 0.5 mm holes allow moisture to leak from the IV tube at 13 mL/hour at equilibrium. Once outside the IV tubing, canvas wicks the moisture away from the tubing and over the interface surface in a physiologically relevant manner. Most moisture is delivered between the ischial regions, with delivery rate decreasing with distance. Using the SMES mounted into the MTS machine the cushion interface microenvironment under relevant conditions of heat, moisture, and load delivery was assessed. 300N load was applied and measurements of the temperature and humidity at the left ischial tuberosity region of the interface were taken every 5 minutes for 120 minutes. The SMES proved to be a reliable tool that maintained its functionality through repeated testing.

The ISO 16840-2 test protocols are benchmarking tests to evaluate a specific mechanical property or ability of wheelchair cushions that are clinically relevant for the end user's experience and cushion's functionality. Although there are no standard target values, it is accepted that an ideal cushion has no hysteresis and is not dependent on past loads when measuring how it compresses under a given load. The modular cushions had less hysteresis than the Jay® cushion and more than either ROHO® cushions. The modular cushions performed better than both commercial cushions under dynamic impact testing, recovery testing and deflection-overload testing, with the fitted cushion performing the best overall under mechanical testing. Under microenvironmental testing, the modular cushion showed improved capabilities to keep the user interface cool and dry. In particular, the modular cushion dissipated moisture slightly more effectively than the commercial cushions.

Thus, the modular cushion, and in particular the fitted modular cushion, performed better than or on par with the most widely prescribed commercially available cushions under ISO 16840-2 mechanical and microenvironmental assessment. A key aspect of the modular cushion is the capability for straight-forward fitting and customization. This is achieved by selecting the correct class of ball for each hole in the foam substrate to optimize pressure distribution over the cushion surface while the user is sitting. A perfectly uniform pressure distribution both minimizes pressure gradients and removes areas of high pressure to prevent pressure injury development due to sitting. The CFA is based on two complementary assumptions:
1) Each ball in the cushion compresses independently from all the other balls.
2) Swapping out balls in the cushion may not significantly affect the compression of a given ball relative to the balls around it.

Interface pressure mapping is recommended as part of a best practice guideline for a clinical assessment of an individual and their seating system and traditionally is used to assess the force distribution between the support surface and a patient's seating contact area. Modular cushion customization takes advantage of this widely available technology to provide a personalized seating support surface. While the preliminary study was carried out using the system available to the study team (i.e., Tekscan CONFORMat®), any pressure mapping system could be used.

CFA input data was acquired from a CONFORMat® interface pressure map obtained from the user sitting on a baseline cushion filled with an array of Class III gel balls for 2-5 minutes. The CFA Matlab® (Mathworks, Natick, MA) routine uses this input data to fit the modular cushion based on ball load-displacement characteristics.

Mean interface pressure on each ball is determined using pre-made templates of regions of interest on the pressure map corresponding to each ball. This data is input to the CFA, and converted to total force. The baseline ball load-displacement curve is used to determine the compression (in mm) experienced by each ball in the baseline cushion. If a ball experiences exactly 0N and is not under load, displacement is set to 0 mm. This position may be left empty without affecting the load distribution of the fitted modular cushion. If a ball experiences 0-2N, the smallest force for which load-displacement data was obtained, load is rounded up to 2N. If a ball saturates at greater than 17N, it is set to 17N. The CFA determines the mean load across all 33 balls in the array and the displacement for each of the five ball classes at the mean load. The CFA then compares the displacement levels of the baseline modular cushion to the levels of displacement for each ball class that would produce the target average load. For each ball position, the CFA selects the ball class which most closely approximates to the mean load.

Using the CFA, areas of high pressure become softer due to placement of higher compliance balls, while areas of low pressure become stiffer due to placement of lower compliance balls. The net result is an increased contact area which relieves peak pressure such as in the ischial tuberosity region. The maximum pressure decreased by 26% and average pressure across the whole cushion decreased by 32%. This change is dramatic, and shows the versatility of the modular approach to the cushion design. Using the CFA, each cushion can be personalized for the user to optimize interface pressure distribution. The fitted modular cushion functions better mechanically than a baseline cushion of moderate compliance gel balls.

Additive manufacturing enables construction of silicone balls with controllable compression properties for the same compression response that are nearly 50% lighter. As with gel balls, the material used to construct the insert is very low cost and generally used for non-clinical applications. Inserts have been constructed using the EnvisionTEC 3D-Bioplotter™ printer to establish proof-of concept. Varying the inner perfactories, or structured interior, modified the stiffness by up to 40%, replicating the variation in the five gel ball classes developed. Preliminary testing also indicates that in addition to being lighter, the additively manufactured insert can be made with modified surface properties so they stick in the containment layer wells.

One of the most important project goals is to minimize the overall cushion cost to the consumer. This not only includes the sticker price for purchasing and customizing a new cushion; it also factors in the cost and expected frequency of cushion component replacement and the functional life of the cushion as compared to other currently available products. A preliminary cost analysis was carried out as an initial benchmark based on construction of the modular cushion using a mix of commercially sourced/custom components. Preliminary tests indicated that the gel balls would be the cushion component with the shortest lifetime. These balls are marketed as stress balls and are put through a great deal of intentional abuse at the hands of their owners, as that is their purpose. The gel balls used in the modular cushion are subjected to considerably less arduous physical loading than the gel balls marketed for stress relief. A 6-month projected life of an individual gel ball was therefore used as a worst case scenario. The annual cost was determined to be nearly 70% less than the commercially available high-performance cushions' estimated yearly cost of $128. Indeed, a user could potentially entirely replace every gel ball 4.3 times per year (every 2.8 months) and still break even.

A strength of the modular cushion concept is that it allows replacement of a single ball at a time, without having to replace the entire cushion. In the event of an early failure of one of more balls, they can readily be replaced to retain function. Normal foam degradation and cover wear can mark the end of the cushion's lifecycle. A preliminary materials cost-analysis indicates that a user could entirely replace every component of the modular cushion several times and maintain a more cost-effective cushion over the complete cushion lifecycle.

Prototypes of the cushion were developed and evaluated using ISO 16840-4 benchmarking mechanical tests, assessment of interface microenvironment conditions and a preliminary clinical satisfaction survey which resulted in positive user feedback.

Comprehensive mechanical and microenvironment testing showed that the modular cushion was successful, performing at least as well as the commercial cushions in all categories tested. It also performed better in dynamic impact, recovery, and deflection-overload tests. The modular cushions performed better at dissipating moisture than commercial cushions, and were better at dissipating heat than a Jay® 2 gel/foam cushion.

The high-performance, low-cost modular cushion has the potential to be of significant value to all Veterans who are wheelchair users, in particular individuals with SCI who are constantly at high risk for pressure injury development. Preliminary materials cost analysis indicates that with even with an average lifetime of only 6 months for each gel ball, a user could entirely replace every component and maintain a personalized high-performance cushion at 70% less cost than the currently available high-performance cushions.

The modular customized cushion can provide a value-driven solution for effective pressure relief for all users. In preliminary testing, therapists requested design of a second generation lighter modular cushion that would be an invaluable assistive technology for many manual wheelchair users. By incorporating additively manufactured silicone-based insert, the next generation modular cushion can provide the same advanced performance at reduced weight.

In order to model the recovery characteristics of each class of insert when placed in the cushion, the load/displacement response in a laterally constrained space can be determined. Compressive force can be applied using masses relevant to forces applied during seating as described herein. Compression can be determined at baseline (T=0) and after 60 minutes of sustained constant loading. Three balls for each class can be tested in triplicate, i.e. three repetitions of each class of insert per applied mass. Surface plots can be generated as described above.

A key aspect of the modular cushion's design is its ability to be fitted and customized for each user. This is achieved by selecting the type of ball to place in each hole in the foam substrate to optimize pressure distribution over the cushion surface while the user is sitting. It was established that the modular cushions, and specifically the fitted modular cushion, perform mechanically at least as well as the commercially available cushions, and in most cases perform better. In order to establish insert performance in the modular cushion layout, ISO 16840-2 mechanical and microenvironmental tests, together with additional non-standard performance tests, can be carried out on six cushion configurations:
1) Baseline modular cushion with 100% gel balls
2) Modular cushion with 100% Class 1 Insert
3) Modular cushion with 100% Class 2 Insert
4) Modular cushion with 100% Class 3 Insert
4) Modular cushion with 100% Class 4 Insert
5) Modular cushion with 100% Class 5 Insert

Cushions can be covered with SmartTempR (Ohio WillowWood, Mt Sterling, Ohio) cushion covers, which combine silicone with the heat management technology of Outlast®, originally developed for NASA, to promote comfortable seating under microenvironmental conditions. A vapor permeable cover can be used in the modular cushion system to enhance moisture and temperature management. Complete cushions can be assessed using ISO 16840-4 test methodologies as detailed herein and using existing test indenters. The purpose of each test and standard outcome variables (METRICS) are summarized below:
Hysteresis can be assessed to determine cushion recovery after repeated cycles of incremental loading, using the RCLI to represent weight shifting during cushion use. METRICS: ISO 16840-4 outcome variables for hysteresis testing: displacement at the end of each loading increment; hysteresis coefficient for 250Nhysteresis coefficient for 500N
Hysteresis can be assessed to determine cushion recovery after repeated cycles of incremental loading, using the RCLI to represent weight shifting during cushion use. METRICS: ISO 16840-4 outcome variables for hysteresis testing: displacement at the end of each loading increment; hysteresis coefficient for 250N; and hysteresis coefficient for 500N.
Impact damping can be assessed using the RCLI to determine the cushion's response to sudden changes in load, such as occur when dropping off a curb or the user dropping suddenly onto the seat during a transfer or following a pressure relief. METRICS: ISO 16840-4 outcome variables for impact damping testing: minimum acceleration experienced during rapid off-loading; and maximum acceleration experienced during rapid off-loading.
Overload response can be assessed to determine the cushion's response to excessive localized pressure, specifically using the LCJ indenter to represent the ischial region. METRICS: ISO 16840-4 outcome variables for overload responses:

$$Loaded contour depth = difference between unloaded cushion displacement ( L 0 ) and displacement under 135 N ( L 135 ) = L 0 - L 1135 \qquad a )$$

$$Overloaded depth = difference between displacement under 135 N load and displacement under 180 N ( L 180 ) = L 135 - L 180 \qquad b )$$

Microenvironment assessment using the SMES assesses changes in the cushion microenvironment under prolonged loading representative of conditions the user experiences due to sitting without pressure relief. The total test period is 2 hours, with changes recorded after a 20 minute stabilization period. METRICS: ISO 16840-4 outcome variables for microenvironmental testing: temperature difference between 100 minutes loading _{(T100)} and stabilization (T0)=T100−T0; time to 33° C.; maximum temperature; relative humidity difference between 100 minutes loading _{(H100)} and stabilization (H0)=H100−H0; time to 12% humidity; and maximum humidity.

Additional non-standard testing includes:
Weighing the completed cushion configurations. Complete cushions can be weighed without and without covers. METRICS: Total cushion weight; and
The effect of repeated disinfection on the load/displacement properties of inserts. In order to determine whether materials properties change due to repeated disinfection, the gel balls and insert can the soaked in 10% Clorox® solution for 24 hours. They can then be air-dried for 24 hours prior to testing the load/displacement response for the highest physiologically relevant load using the protocol described above. In order to be representative of the need for cleaning in clinical use, the test can be repeated five times at weekly intervals. METRICS: Difference between high load/displacement response before and after cleaning (CD1700=Displacement change under 1200 g load after cleaning).
The effect of cooling on the load/displacement properties of inserts. In order to determine the effect of prolonged cooling on material properties, the gel balls and insert can be cooled overnight on a lab refrigerator. The load/displacement response for the highest physiologically relevant load using the protocol described above can then be tested immediately upon removal from the cooled environment. The test can be repeated in triplicate for each class of gel ball and insert. METRICS: Difference between high load/displacement response before and after overnight cooling (CD1700—Displacement change under 1200 g load after overnight cooling).
   If the insert becomes less tacky over time, the shape of the insert can be modified.

A perfectly uniform pressure distribution would result in no areas of high pressure, thus decreasing the risk of pressure injury formation. Application of the cushion fitting algorithm (CFA) enables a fitted modular cushion that provides better pressure relief than an unfitted baseline cushion. This change is dramatic, and shows the versatility of the modular approach to the cushion design. Using the CFA, each cushion can be personalized for the user to optimize interface pressure distribution.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A compressible element comprising:
a resilient material arranged in an open structure having predetermined geometry to provide a desired mechanical property.

Aspect 2: The compressible element of aspect 1, wherein the resilient material further comprises an outer shell that at least partially surrounds the open structure.

Aspect 3: The compressible element of aspect 2, wherein the outer shell fully surrounds the open structure.

Aspect 4: The compressible element of any one of the preceding aspects, wherein the compressible element has a domed upper surface.

Aspect 5: The compressible element of aspect 4, wherein the domed upper surface is hemispherical or generally hemispherical.

Aspect 6: The compressible element of any one of the preceding aspects, wherein the open structure comprises a lattice, the lattice comprising a plurality of crossing material segments.

Aspect 7: The compressible element of aspect 6, wherein the plurality of crossing material segments are straight or substantially straight.

Aspect 8: The compressible element of aspect 7, wherein the open structure comprises triangular prism spaces between the lattice.

Aspect 9: The compressible element of aspect 6, wherein the plurality of crossing material segments are wavy.

Aspect 10: The compressible element of any one of the preceding aspects, wherein at least a portion of the open structure comprises a gyroid infill.

Aspect 11: The compressible element of any one of the preceding aspects, wherein the predetermined geometry comprises a volumetric density of the open structure.

Aspect 12: The compressible element of aspect 11, wherein the open structure comprises a lattice, the lattice comprising a plurality of crossing material segments, wherein the volumetric density is determined at least in part by selected spacings along a transverse axis between adjacent segments.

Aspect 13: The compressible element of aspect 1, wherein the compressible element comprises a plurality of regions having respective predetermined mechanical properties.

Aspect 14: The compressible element of aspect 13, wherein the respective predetermined mechanical properties of the plurality of regions are based on a pressure map of a particular individual.

Aspect 15: The compressible element of aspect 13 or aspect 14, wherein the compressible element is sized to provide cushioning for substantially an entire seat.

Aspect 16: A pad comprising:
a frame defining a plurality of receptacles; and
a plurality of compressible elements as in any one of the preceding aspects, wherein a respective compressible element of the plurality of compressible elements is positioned within each receptacle of the plurality of receptacles.

Aspect 17: The pad of aspect 16, wherein each compressible element is provided to have the same or substantially similar material properties as each other compressible element of the plurality of compressible elements.

Aspect 18: The pad of aspect 16, wherein a first compressible element is provided to have at least one material property that differs from at least one other compressible element of the plurality of compressible elements.

Aspect 19: The pad of aspect 18, wherein the first compressible element and the at least one other compressible element comprise the same material, the first compressible element differs from the at least one other compressible element based on the respective predetermined geometry of the open structure of each of the first compressible element and the at least one other compressible element.

Aspect 20: The pad of any one of aspects 16-19, further comprising a cover defining an interior, wherein the frame and plurality of compressible elements are received within the interior of the cover.

Aspect 21: The pad of any one of aspects 16-19, wherein the plurality of compressible elements are selectively removable from the frame of the pad (to permit selective replacement of compressible elements within the frame).

Aspect 22: A wheelchair seating system comprising:
a seat overlay, the seat overlay comprising a pad as in aspect 16.

Aspect 23: A method comprising:
3D printing a compressible element as in any one of aspects 1-15.

Aspect 24: The method of aspect 23, further comprising:
obtaining a pressure map of a user seated on a surface;
determining the predetermined geometry of the open structure of the resilient material of the compressible element;
wherein 3D printing the compressible element comprises 3D printing the compressible element to have the open structure having the predetermined geometry.

Aspect 25: The method of aspect 23 or aspect 24, further comprising 3D printing plurality of additional compressible elements, each compressible element of the additional compressible elements comprising:
a resilient material arranged in an open structure having predetermined geometry to provide a desired mechanical property.

Aspect 26: A wheelchair comprising: a seat overlay, the seat overlay comprising a pad as in aspect 16.

Although the foregoing invention has been described in some detail by way of illustration and example for purposes of clarity of understanding, certain changes and modifications may be practiced within the scope of the appended claims.

1. A compressible element comprising:
a resilient material arranged in an open structure having predetermined geometry to provide a desired mechanical property.

2. The compressible element of claim 1, wherein the resilient material further comprises an outer shell that at least partially surrounds the open structure.

3. (canceled)

4. The compressible element of claim 1, wherein the compressible element has a domed upper surface.

5. (canceled)

6. The compressible element of claim 1, wherein the open structure comprises a lattice, the lattice comprising a plurality of crossing material segments.

7. (canceled)

8. (canceled)

9. (canceled)

10. The compressible element of claim 1, wherein at least a portion of the open structure comprises a gyroid infill.

11. The compressible element of claim 1, wherein the predetermined geometry comprises a volumetric density of the open structure.

12. The compressible element of claim 11, wherein the open structure comprises a lattice, the lattice comprising a plurality of crossing material segments, wherein the volumetric density is determined at least in part by selected spacings along a transverse axis between adjacent segments.

13. The compressible element of claim 1, wherein the compressible element comprises a plurality of regions having respective predetermined mechanical properties.

14. The compressible element of claim 13, wherein the respective predetermined mechanical properties of the plurality of regions are based on a pressure map of a particular individual.

15. The compressible element of claim 13, wherein the compressible element is sized to provide cushioning for substantially an entire seat.

16. A pad comprising:
a frame defining a plurality of receptacles; and
a plurality of compressible elements as in claim 1, wherein a respective compressible element of the plurality of compressible elements is positioned within each receptacle of the plurality of receptacles.

17. The pad of claim 16, wherein each compressible element is provided to have the same or substantially similar material properties as each other compressible element of the plurality of compressible elements.

18. The pad of claim 16, wherein a first compressible element is provided to have at least one material property that differs from at least one other compressible element of the plurality of compressible elements.

19. The pad of claim 18, wherein the first compressible element and the at least one other compressible element comprise the same material, the first compressible element differs from the at least one other compressible element based on the respective predetermined geometry of the open structure of each of the first compressible element and the at least one other compressible element.

20. The pad of claim 16, further comprising a cover defining an interior, wherein the frame and plurality of compressible elements are received within the interior of the cover.

21. The pad of claim 16, wherein the plurality of compressible elements are selectively removable from the frame of the pad.

22. A wheelchair seating system comprising:
a seat overlay, the seat overlay comprising a pad as in claim 16.

23. A method comprising:
3D printing a compressible element as in claim 1.

24. The method of claim 23, further comprising:
obtaining a pressure map of a user seated on a surface;
determining the predetermined geometry of the open structure of the resilient material of the compressible element;
wherein 3D printing the compressible element comprises 3D printing the compressible element to have the open structure having the predetermined geometry.

25. The method of claim 24, further comprising 3D printing a plurality of additional compressible elements, each compressible element of the additional compressible elements comprising:
a resilient material arranged in an open structure having predetermined geometry to provide a desired mechanical property.
